(19) United States
(12) Patent Application Publication
(10) Pub. No.: US 2015/0348109 A1
(43) Pub. Date: Dec. 3, 2015

(54) INTENT-DRIVEN TARGETING IN SOCIAL NETWORK ADVERTISING

(71) Applicant: Kenshoo Ltd., Tel Aviv (IL)

(72) Inventors: Tal Hasson, Petach Tikva (IL); Zvika Goldstein, San Francisco, CA (US); Nir Cohen, San Francisco, CA (US)

(21) Appl. No.: 14/721,368

(22) Filed: May 26, 2015

Related U.S. Application Data
(60) Provisional application No. 62/003,100, filed on May 27, 2014.

(51) Int. Cl. G06Q 30/02

(52) U.S. Cl. CPC G06Q 30/0256; G06Q 30/0269

(57) ABSTRACT

A method for user targeting in a social advertising platform, the method comprising using at least one hardware processor for: linking between interaction of users with search engine advertisements and profiles of the users in a social network; and targeting the users, within a social advertising platform associated with the social network, based on (a) the interaction of the users with the search engine advertisements, and (b) social targeting criteria associated with the users.

### CROSS-REFERENCE TO RELATED APPLICATIONS

This application claims the benefit of U.S. Provisional Patent Application No. 62/003,100, filed May 27, 2014 and entitled “Intent-Driven Targeting in Social Network Advertising”, the contents of which are incorporated herein by reference in their entirety.

### FIELD OF THE INVENTION

Present embodiments relate to the field of online advertising technology, also known as “ad-tech”.

### BACKGROUND

Advertising using traditional media, such as television, radio, newspapers and magazines, is well known. Unfortunately, even when armed with demographic studies and entirely reasonable assumptions about the typical audience of various media outlets, advertisers recognize that much of their advertising budget is oftentimes simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their advertisements (also “ads”) to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif., delivers ads targeted to keywords from search queries. Similarly, content-targeted ad delivery systems have been proposed. For example, U.S. Pat. No. 7,716,161 to Dean et al. and U.S. Pat. No. 7,136,875 to Anderson et al. describe methods and apparatuses for serving ads relevant to the content of a document, such as a web page. Content-targeted ad delivery systems, such as the AdSense advertising system by Google for example, have been used to serve ads on web pages.

AdSense is part of what is often called advertisement syndication, which allows advertisers to extend their marketing reach by distributing advertisements to additional partners. For example, third party online publishers can place an advertiser's text or image advertisements on web pages that have content related to the advertisement. This is often referred to as “contextual advertising”. As the users are likely interested in the particular content on the publisher web page, they are also likely to be interested in the product or service featured in the advertisement. Accordingly, such targeted advertisement placement can help drive online customers to the advertiser's website.

Optimal ad placement has become a critical competitive advantage in the Internet advertising business. Consumers are spending an ever-increasing amount of time online, looking for information. The information, provided by Internet content providers, is viewed on a page-by-page basis. Each page can contain written and graphical information as well as one or more ads. Key advantages of the Internet, relative to other information media, are that each page can be customized to fit a customer profile and ads can contain links to other Internet pages. Thus, ads can be directly targeted at different customer segments. For example, ad targeting is nowadays possible based on the geographic location of the advertiser and/or the customer, the past navigation path of the customer outside or within the web site, the language used by the visitor's web browser, the purchase history on a website, the behavioral intent influenced by the user's action on the site, and more.

Furthermore, the ads themselves are often designed and positioned to form direct connections to well-designed Internet pages. The concept referred to as “native advertising” offers ads which more naturally blend into a page's design, in cases where advertiser's intent is to make the paid advertising feel less intrusive and, therefore, increase the likelihood users will click on it.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method for user targeting in a social advertising platform, the method comprising using at least one hardware processor for: linking between interaction of users with search engine advertisements and profiles of the users in a social network; and targeting the users, within a social advertising platform associated with the social network, based on (a) the interaction of the users with the search engine advertisements, and (b) social targeting criteria associated with the users.

There is further provided, in accordance with an embodiment, a system for user targeting in a social advertising platform, the system comprising: (a) a non-transient computer-readable storage medium having stored thereon instructions for: linking between interaction of users with search engine advertisements and profiles of the users in a social network, and targeting the users, within a social advertising platform associated with the social network, based on (i) the interaction of the users with the search engine advertisements, and (ii) social targeting criteria associated with the users; and (b) at least one hardware processor configured to execute the instructions.

There is further provided, in accordance with an embodiment, a computer program product for user targeting in a social advertising platform, the computer program product comprising a non-transient computer-readable storage medium having stored thereon instructions which, when executed by at least one hardware processor, cause the processor to: link between interaction of users with search engine advertisements and profiles of the users in a social network; and target the users, within a social advertising platform associated with the social network, based on (a) the interaction of the users with the search engine advertisements, and (b) social targeting criteria associated with the users.

There is further provided, in accordance with an embodiment, a method for user targeting in a social advertising platform, the method comprising using at least one hardware processor for: linking between interaction of users with mobile apps and profiles of the users in a social network; and targeting the users, within a social advertising platform associated with the social network, based on (a) the interaction of the users with the mobile apps, and (b) social targeting criteria associated with the users.

Optionally, said linking comprises: causing cookies to be created in computers of the users, the cookies comprising data associated with the interaction of the users with the search engine advertisements and unique identifiers of the users; and upon the users accessing the social network, scanning the computers of the users to identify the cookies.

Optionally, the data associated with the interaction of the users with the search engine advertisements is selected from the group consisting of: a term searched for in the search engine, an identifier of each of the search engine advertisements, and a product identifier.

Optionally, said linking further comprises associating the unique identifiers of the users included in the cookies with unique identifiers of the users in the social network.

Optionally, said targeting comprises displaying advertisements to the users in the social network.

Optionally, the social targeting criteria are selected from the group consisting of: location, gender, age, likes and interests, relationship status, workplace and education.

Optionally, the method further comprises affecting an advertising parameter on the social advertising platform, wherein the advertising parameter is selected from the group consisting of: a bid, a budget and an advertisement creative.

Optionally, said non-transient computer-readable storage medium further comprises instructions for affecting an advertising parameter on the social advertising platform, wherein the advertising parameter is selected from the group consisting of: a bid, a budget and an advertisement creative.

Optionally, said linking comprises: triggering API (Application Program Interface) calls from the mobile apps to the social advertising platform upon the interaction of the users with the mobile apps.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. The figures are listed below:

FIG. 1 shows a schematic of an example of a cloud computing node;

FIG. 2 shows an illustrative cloud computing environment; and

FIG. 3 shows a set of functional abstraction layers provided by the cloud computing environment of FIG. 2.

### DETAILED DESCRIPTION

Disclosed herein is a method for intent-driven user targeting in a social advertising platform. Advantageously, the method enables deducing a behavioral intent of the user, based on his or her interaction with one or more search engine advertisements, and then utilizing that intent for targeting the same user in the social advertising platform. The intent of the user may be deduced, for example, based on the search term he or she used in the search engine. Additionally or alternatively, one or more metrics associated with the search engine advertisement may be used in order to later target the user in the social advertising platform. Namely, the disclosed targeting method may harness insight from both search engine marketing and social advertising realms, to offer advertisers precise and well-founded targeting of their advertising efforts. The targeting in the social advertising platform may be based on creating groups of users having similar search and/or social characteristics.

Further embodiments relate to deducing the behavioral intent of a user based on his or her interaction with one or more mobile apps. The term “mobile app” relates to a software application running on a portable computing device, such as a mobile phone, a smart phone, a tablet computer, etc. Groups of users may be targeted, in the social advertising platform, based on their similar interaction with the one or more mobile apps.

### Glossary

“Online advertising platform” (or simply “advertising platform”): This term, as referred to herein, may relate to a service offered by an advertising business to different advertisers. In the course of this service, the advertising business serves ads, on behalf of the advertisers, to Internet users. Each advertising platform usually services a large number of advertisers, who compete on advertising resources available through the platform. The competition is oftentimes carried out by conducting some form of an auction, where advertisers bid on advertising resources. The ads may be displayed (and/or otherwise presented) in various web sites which are affiliated with the advertising business (these web sites constituting what is often referred to as a “display network”) and/or in one or more web sites operated directly by the advertising business. To aid advertisers in neatly organizing their ads, advertising platforms often allow grouping individual ads in sets, such as the “AdGroups” feature in Google AdWords (a service operated by Google, Inc. of Mountain View, Calif.). The advertiser may decide on the logic behind such grouping, but it is common to have ads grouped by similar ad copies, similar targeting, etc. Advertising platforms may allow an even more abstract way to group ads; this is often called a “campaign”. A campaign usually includes multiple sets of ads, with each set including multiple ads. An advertiser may control the cost it spends on online advertising by assigning a budget per individual ad, a group of ads or the like. The budget may be defined for a certain period of time.

“Search advertising platform”: A type of advertising platform in which ads are served to Internet users responsive to search engine queries executed by the users. The ads are typically displayed alongside the results of the search engine query. AdWords is a prominent example of a search advertising platform. In AdWords, advertisers can choose between displaying their ads in a display network and/or in Google's own search engine; the former involves the subscription of web site operators (often called “publishers”) to Google's AdSense program, whereas the latter, often referred to as SEM (Search Engine Marketing), involves triggering the displaying of ads based on keywords entered by users in the search engine.

“Social advertising platform”: A further type of advertising platforms, commonly referred to as a “social” advertising platform, involves the displaying of ads to users of online social networks. An online social network is often defined as a set of dyadic connections between persons and/or organizations, enabling these entities to communicate over the Internet. In social advertising, both the advertisers and the users enjoy the fact that the displayed ads can be highly tailored to the users viewing them. This feature is enabled by way of analyzing various demographics and/or other parameters of the users (jointly referred to as “targeting criteria”)—parameters which are readily available in many advertising platforms of social networks and are usually provided by the users themselves. Facebook Ads, operated by Facebook, Inc. of Menlo Park, Calif., is such an advertising platform. LinkedIn Ads, by LinkedIn Corporation of Mountain View, Calif., is another.

“Online ad entity” (or simply “ad entity”): This term, as referred to herein, may relate to an individual ad, or, alternatively, to a set of individual ads, run by an advertising platform. An individual ad, as referred to herein, may include an ad copy, which is the text, graphics and/or other media to be served (displayed and/or otherwise presented) to users. The ad copy may also include a link, in URL (Uniform Resource Locator) format, to a landing page. The term “landing page” refers to a web page, commonly in HTML (HyperText Markup Language) format. In addition, an individual ad may include and/or be associated with a set of parameters, such as searched keywords to target, geographies to target, demographics to target, a bid for utilization of advertising resources of the advertising platform, and/or the like. Sometimes, the bid may set for a particular parameter instead of or in addition to setting a global bid for the ad entity; for example, a bid may be per keyword, geography, etc.

“Reach”: the number of users which fit certain targeting criteria of an ad entity. This is the number of users to which that ad entity can be potentially displayed. The “reach” metric is common in social advertising platforms, such as Facebook.

“Search volume”: the number of average monthly searches (or searches over another period of time) for a certain search term. The search volume is often provided by search advertising platforms, such as Google AdWords.

“Performance”: This term, as referred to herein with regard to an ad, may relate to various statistics gathered in the course of running the ad. A “running” phase of the ad may refer to a duration in which the ad was served to users, or at least to a duration during which the advertiser defined that the ad should be served. The term “performance” may also relate to an aggregate of various statistics gathered for a set of ads, a campaign, etc. The statistics may include multiple parameters (also “performance metrics”). Exemplary performance metrics are:
“Impressions”: the number of times the ad has been served to users during a given time period (e.g. a day, an hour, etc.);
“Frequency”: the average number of times a user has been exposed to the same ad, calculated as the ratio of total number of impressions to the number of unique impressions (i.e. the number of unique users exposed to that ad). This metric is very common in social advertising platforms;
“Clicks”: the number of times users clicked (or otherwise interacted with) the ad entity during a given time period (e.g. a day, an hour, etc.);
“Cost per click (CPC)”: the average cost of a click (or another interaction with an ad entity) to the advertiser, calculated as the total cost for all clicks divided by the number of clicks;
“Cost per impression”: the average cost of an impression to the advertiser, calculated as the total cost for all impressions divided by the number of impressions;
“Click-through rate (CTR)”: the ratio between clicks and impressions of the ad entity, namely—the number of clicks divided by the number of impressions;
“Conversions”: the number of times in which users who clicked (or otherwise interacted with) the ad entity have consecutively accepted an offer made by the advertiser during a given time period (e.g. a day, an hour, etc.). For examples, users who purchased an advertised product, users who subscribed to an advertised service, users who downloaded a mobile application, or users who filled in their details in a lead generation form;
“Conversion rate (CR)”: the total number of conversions divided by the total number of clicks;
“Return on investment (ROI)” or “Return on advertising spending (ROAS)”: the ratio between the amount of revenue generated as a result of online advertising, and the amount of investment in those online advertising efforts. Namely—revenue divided by expenses;
“Revenue per click”: the average amount of revenue generated to the advertiser per click (or another interaction with an ad entity), calculated by dividing total revenue by total clicks;
“Revenue per impression”: the average amount of revenue generated to the advertiser per impression of the ad entity, calculated by dividing total revenue by total impressions;
“Revenue per conversion”: the average amount of revenue generated to the advertiser per conversion, calculated by dividing total revenue by total conversions;
“Unique-impressions-to-reach ratio”: the ratio between the number of unique impressions (i.e. impressions by different users, ignoring repeated impressions by the same user) and the reach of the ad entity. This ratio represents the realized portion of the reach.
“Spend rate”: the percentage of utilized budget per a certain time period (e.g. a day) for which the budget was defined. In many scenarios, even if an advertiser assigns a certain budget for a certain period of time, not the entire budget is consumed during that period. The spend rate metric measures this phenomenon.
“Quality score”: a score often provided by advertising platforms for each ad entity. For example, Google AdWords assigns a quality score between 1 and 10 to each individual ad. Factors which determine the quality score include, for example, CTR, ad copy relevance, landing page quality and/or other factors. The quality score, together with the bids placed by the advertiser, are usually the factors which affect the results of the competition between different advertisers on advertising resources.
“Potential reach”: defined as 1 minus the unique-impressions-to-reach ratio. The higher the potential reach, the more users are left to display the ad entity to.

“Proportional performance metrics”: those of the above performance metrics (or other performance metrics not discussed here) which denote a proportion between two performance metrics which are absolute values. Merely as one example, CTR is a proportional performance metric since it denotes the proportion between clicks (an absolute value) and impressions (another absolute value). As an alternative, a proportional performance metric may be a proportion between an absolute performance metric and another parameter, such as time. As yet another alternative, a proportional performance metric may be a certain mathematic manipulation of a proportion between two absolute performance metrics; the “potential reach” is an example, since it is defined as 1 minus the unique-impressions-to-reach ratio.

“HTTP Cookie” (or simply “cookie”): As defined in A. Barth, “HTTP State Management Mechanism”, IETF, RFC 6265, April 2011. [Online]. Available at: http://tools.ietf.org/html/rfc6265. This RFC is incorporated herein by reference in its entirety.

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

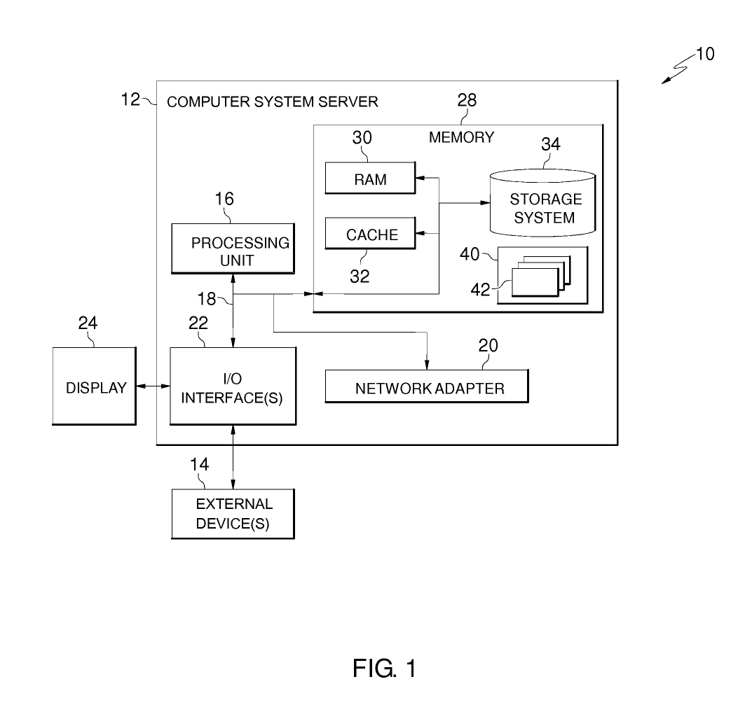

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system.

Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

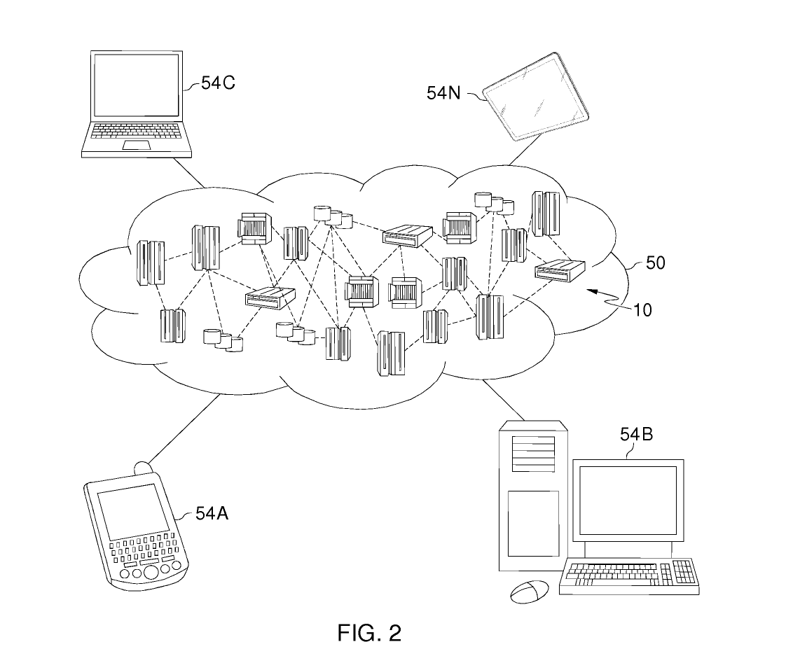

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or tablet computing device 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

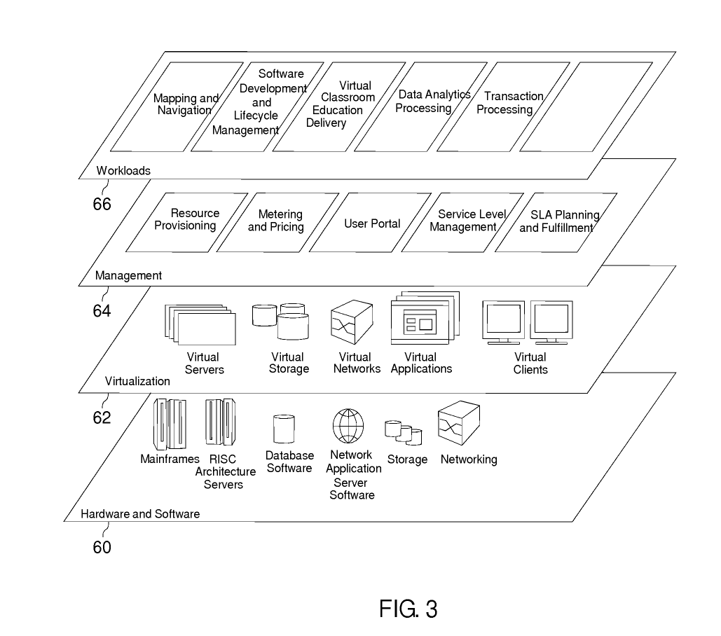

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, RISC (Reduced Instruction Set Computer) architecture based servers; storage devices; networks and networking components. Examples of software components include network application server software; and database software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; and data analytics processing; transaction processing.

### Deducing User Intent from Search Engine Interaction

As briefly discussed above, disclosed herein is a targeting method which may harness insight from both search engine marketing and social advertising realms, to offer advertisers precise and well-founded targeting of their advertising efforts. The term “targeting”, as referred to herein, may relate to the displaying of online advertisements to users, wherein the displaying is within websites (viewed using web browser software) and/or within various software applications—whether desktop software applications or mobile software applications operable in smart phones, tablets computers, etc.

Practically, the method may include an initial step of linking between (a) interaction of users with search engine advertisements and (b) profiles of the same users in a social network. This step may include, for example, the creation of a cookie in a computer of each of the users, upon that user interacting with a search engine advertisement (e.g. clicking on the advertisement). The cookie may be created by an intermediate remote server through which traffic from the search engine advertisement to a landing page is redirected, via the Internet. Another option is to create the cookie by the landing page itself.

The cookie may either include data associated with that interaction (e.g. a term searched for in the search engine, an ad identifier, a product identifier, etc.), or include a unique identifier which enables a later fetching of such data from a remote server, as well as additional data collected from previous engagements of same user with the same or different search engine advertisements.

Upon the user accessing the social network with which the social advertising platform is associated, the user's cookie may be identified (for example, by having the social network advertising platform associate their user unique ID with a user unique ID included in the cookie and identifying the user in his or her search engine interactions). Once the cookie is identified, a link is deduced between the interaction of the user with the search engine advertisement and the profile of that user in the social network. Based on the link, data associated with user intent may be periodically communicated to the social advertising platform, such that the user intent is available when later targeting the users in advertising via the social advertising platform.

The method may be implemented, for example, in association with the Custom Audiences feature of the Facebook Ads social advertising platform, or any other similarly-operable feature of the same or a different advertising platform. Custom Audiences is an ad targeting option that lets advertisers find their existing audiences among users who have social profiles on the Facebook social network. An advertiser, according to present embodiments, may cluster users who interact with its search engine advertisements into different Custom Audiences on Facebook Ads. Namely, the advertiser may create different Custom Audiences which segment the users based on user intent data gathered in association with the search engine advertisement interaction. For example, the Custom Audiences may segment the users according to the term searched for in the search engine, and/or additional data associated with the intent of these users. This data may include, to name a few exemplary parameters:
Campaign.
Adgroup.
Ad.
Targeted Keyword(s).
Product Target.
Times (of clicks, conversions etc.).
User Location.
Landing Page.
For each such parameter, the insight it adds about a particular user may be divided into at least two dimensions: First, the actual value indicator, for example: the keyword string, the campaign name etc. Second, a performance metric for the value indicator, for example, the conversion rate of the keyword, the click value of the keyword, the conversion rate of the campaign etc.
In another example, the value indicator is the Life Time Value (LTV) of the user and the associated metric will be projected revenue generated from the user. This data may be generated from an internal prediction algorithm situated in the remote server, or from third party.

In order for Facebook Ads to receive user intent data about the users, a server which holds that data (optionally the intermediate remote server discussed above, or a different server) may periodically communicate the data to Facebook Ads, for example by uploading a configuration file, such as a CSV (Comma Separated Values) file, to Facebook Ads. See https://www.facebook.com/help/459892990722543, last accessed May 15, 2014, for a further description, Alternatively, the data may be communicated to Facebook Ads in real time via an API of Facebook Ads; see https://developers.facebook.com/docs/reference/ads-api/custom-audience-targeting, last accessed May 15, 2014, for a further description.

The data communicated to Facebook Ads may further include user segmentation according to the aforementioned parameters. This segmentation may be automatically performed by the server which holds the user intent data.

In this exemplary Facebook Ads implementation, targeting an advertisement may then be performed based both on the targeting criteria offered by Facebook Ads (e.g. location, gender, age, likes and interests, relationship status, workplace, education, etc.), and of the user intent data gathered in association with the search engine advertisement interaction.

In addition or as an alternative to affecting the targeting on the social advertising platform, one or more other advertising parameters may be affected on the social advertising platform based on the user intent data. For example, bids, budgets, ad creatives (e.g. text, image, landing page), etc. may be affected.

The following are a few exemplary options for utilizing the user intent data when advertising using the social advertising platform, such as Facebook Ads:
Target male users in Germany who clicked on advertisements of top performing campaigns, keywords, etc.
Utilize the keyword bid, average CPC, click value etc. in the search engine to change the bid in the social advertising platform.
Calculate a user value (i.e. Life Time Value) based on the above mentioned parameters.
Customize and/or personalize creative text, image and/or landing page based on the ad and/or keyword in the search engines.
Understand and assign a score to the user's brand affinity.
Increase budget of campaign which targets male users in Germany who clicked on advertisements of top performing campaigns and/or keywords, since there is an increase in the number of users in this group for the past X hours\days.
Initiate a new campaign or stop an existing one based on the size of a custom audience group or based on the fact that a new Custom Audience group was created/removed.
Utilize the product value/margin/price that a user clicked on an ad associated with (for example, via Google Shopping Campaigns) in order to define the bid.

### Deducing User Intent from Mobile App Interaction

As briefly discussed above, further embodiments may deduce the user intent from his or her interaction with one or more mobile apps, in addition to the interaction with a search engine advertisement. The deduced user intent may then be used for targeting within a social advertising network, as already discussed above at length. The mobile app interactions may be communicated to the social advertising network upon their occurrence or periodically. Facebook Ads, for example, enables mobile app developers to use certain Facebook SDK (Software Development Kit) in the apps, such that user interaction with the app triggers an API (Application Program Interface) to Facebook Ads, enabling the creation or the addition to a Custom Audience.

The user interaction with the mobile app may optionally be classified, automatically, as “positive” or “negative”. Positive interaction may include, for example, the installation of the app, upgrading it, opening it, using it, performing an in-app purchase, etc. Negative interaction may include, for example, refusing to a prompt to upgrade the app, refusing to an in-app purchase prompt, uninstalling the app, etc. Then, Custom Audiences may be created based on such positive and/or negative interactions.

According to some embodiments, once the mobile interaction occurs, additional data associated with user intent from its past search activity may be fetched from a remote server in order to enrich the interaction and provide a better granularity/definition of the event, which will be then used for the creation of social targeting (ie. Custom Audience).

For example, a certain user may install a mobile app and register to a certain service provided by the app. Prior to sending these two events to the social advertising platform, the events will be enriched (for example, via an HTTP request to a remote server) based on the user's prior search activity and associated performance data. For example, the user may have previously searched for the keyword “Trading Account” which has a conversion rate of 5% in Germany, according to accumulated information stored at the remote server.

In the present example, this enrichment enables a more granular targeting of this user in the social advertising platform. The two events that will be sent to the social advertising platform in this case will be more precise, such as: 1) Install event of a user who searched for the “Trading Account” keyword which has a conversion rate of 5% in Germany. 2) Registration event for a certain service by the user, who searched for the “Trading Account” keyword which has a conversion rate of 5% in Germany.

Accordingly, an advertiser can now create much more precise targeting, such as with Facebook's Custom Audiences feature, with better granularity based on rules of the mobile app events, such as:
4. Group of all users who installed App B and searched the keyword “Trading Account”.
5. Group of all users who installed and looked for the keyword “Trading Account” but did not register.
6. Group of all users who installed App B and searched and clicked on keywords with a conversion rate of 5% and above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated.

What is claimed is:

1. A method for user targeting in a social advertising platform, the method comprising using at least one hardware processor for:
linking between interaction of users with search engine advertisements and profiles of the users in a social network; and
targeting the users, within a social advertising platform associated with the social network, based on (a) the interaction of the users with the search engine advertisements, and (b) social targeting criteria associated with the users.

2. The method according to claim 1, wherein said linking comprises:
causing cookies to be created in computers of the users, the cookies comprising data associated with the interaction of the users with the search engine advertisements and unique identifiers of the users; and
upon the users accessing the social network, scanning the computers of the users to identify the cookies.

3. The method according to claim 2, wherein the data associated with the interaction of the users with the search engine advertisements is selected from the group consisting of: a term searched for in the search engine, an identifier of each of the search engine advertisements, and a product identifier.

4. The method according to claim 2, wherein said linking further comprises associating the unique identifiers of the users included in the cookies with unique identifiers of the users in the social network.

5. The method according to claim 2, wherein said targeting comprises displaying advertisements to the users in the social network.

6. The method according to claim 2, wherein the social targeting criteria are selected from the group consisting of: location, gender, age, likes and interests, relationship status, workplace and education.

7. The method according to claim 2, further comprising affecting an advertising parameter on the social advertising platform, wherein the advertising parameter is selected from the group consisting of: a bid, a budget and an advertisement creative.

8. A system for user targeting in a social advertising platform, the system comprising:
(a) a non-transient computer-readable storage medium having stored thereon instructions for:
linking between interaction of users with search engine advertisements and profiles of the users in a social network, and
targeting the users, within a social advertising platform associated with the social network, based on (i) the interaction of the users with the search engine advertisements, and (ii) social targeting criteria associated with the users; and
(b) at least one hardware processor configured to execute the instructions.

9. The system according to claim 8, wherein said linking comprises:
causing cookies to be created in computers of the users, the cookies comprising data associated with the interaction of the users with the search engine advertisements and unique identifiers of the users; and
upon the users accessing the social network, scanning the computers of the users to identify the cookies.

10. The system according to claim 9, wherein the data associated with the interaction of the users with the search engine advertisements is selected from the group consisting of: a term searched for in the search engine, an identifier of each of the search engine advertisements, and a product identifier.

11. The system according to claim 9, wherein said linking further comprises associating the unique identifiers of the users included in the cookies with unique identifiers of the users in the social network.

12. The system according to claim 9, wherein said targeting comprises displaying advertisements to the users in the social network.

13. The system according to claim 9, wherein the social targeting criteria are selected from the group consisting of: location, gender, age, likes and interests, relationship status, workplace and education.

14. The system according to claim 9, wherein said non-transient computer-readable storage medium further comprises instructions for affecting an advertising parameter on the social advertising platform, wherein the advertising parameter is selected from the group consisting of: a bid, a budget and an advertisement creative.

15. A computer program product for user targeting in a social advertising platform, the computer program product comprising a non-transient computer-readable storage medium having stored thereon instructions which, when executed by at least one hardware processor, cause the processor to:
link between interaction of users with search engine advertisements and profiles of the users in a social network; and
target the users, within a social advertising platform associated with the social network, based on (a) the interaction of the users with the search engine advertisements, and (b) social targeting criteria associated with the users.

16. The computer program product according to claim 15, wherein said link comprises:
causing cookies to be created in computers of the users, the cookies comprising data associated with the interaction of the users with the search engine advertisements and unique identifiers of the users; and
upon the users accessing the social network, scanning the computers of the users to identify the cookies.

17. The computer program product according to claim 16, wherein the data associated with the interaction of the users with the search engine advertisements is selected from the group consisting of: a term searched for in the search engine, an identifier of each of the search engine advertisements, and a product identifier.

18. The computer program product according to claim 16, wherein said link further comprises associating the unique identifiers of the users included in the cookies with unique identifiers of the users in the social network.

19. The computer program product according to claim 16, wherein said targeting comprises displaying advertisements to the users in the social network.

20. The computer program product according to claim 16, wherein the social targeting criteria are selected from the group consisting of: location, gender, age, likes and interests, relationship status, workplace and education.

21. The computer program product according to claim 16, wherein said instructions are further executable to affect an advertising parameter on the social advertising platform, wherein the advertising parameter is selected from the group consisting of: a bid, a budget and an advertisement creative.

22. A method for user targeting in a social advertising platform, the method comprising using at least one hardware processor for:
linking between interaction of users with mobile apps and profiles of the users in a social network; and
targeting the users, within a social advertising platform associated with the social network, based on (a) the interaction of the users with the mobile apps, and (b) social targeting criteria associated with the users.

23. The method according to claim 22, wherein said linking comprises:
triggering API (Application Program Interface) calls from the mobile apps to the social advertising platform upon the interaction of the users with the mobile apps.
